(19) United States
(12) Patent Application Publication
(10) Pub. No.: US 2011/0282706 A1
(43) Pub. Date: Nov. 17, 2011

(54) ORGANIZATION MANAGEMENT TOOL

(75) Inventors: Meir Ezra, Saint Petersburg, FL (US); Pavel Strnad, Prague 3 (CZ)

(73) Assignee: Timemaker LLC, Clearwater, FL (US)

(21) Appl. No.: 12/674,161

(22) PCT Filed: Aug. 20, 2008
(86) PCT No.: PCT/IB08/53338

§ 371 Date: Feb. 19, 2010

Related U.S. Application Data
(60) Provisional application No. 60/956,747, filed on Aug. 20, 2007.

(51) Int. Cl. G06Q 10/00; G06F 17/30

(52) U.S. Cl. 705/7.15; 707/802; 707/622; 707/E17.005

(57) ABSTRACT

An organizational management tool that involves a limited yet expansive amount of interconnectable nodes within a unique network. A node in the context of the present invention is an apparatus such as a computer that communicates with a database server (DBS). The interaction between such nodes complies with a set of functional rules and topological considerations. An apparatus such as a computer that is not connected to the DBS and has an internet access referred to hereinafter as an external node. External nodes are connectable to the system of the invention usually through non-specific communications channels such as regular email connections. Any node can be defined by the administrator as being either senior or junior with respect to another node. This hierarchical feature together with other features dictates specific task flow properties and connectivity characteristics between nodes, as well as data access of nodes to main data base. Each node employs a special visual interface (VI) which updates nodes regarding statuses and processes in the system.

### FIELD OF THE INVENTION

The present invention is in the field of organization management. More specifically the invention is about managing firm workers' tasks, productivity, planning, meetings and data.

### BACKGROUND OF THE INVENTION

Organization management is the discipline of organizing and managing resources in such a way that these resources deliver all the work required to implement firm objectives within defined scope, time and cost constraints. Project management software is a term covering many types of software, including scheduling, resource allocation, collaboration software, communications and documentation systems, which are used to deal with the complexity of large projects. MS Project® (MSP) is an example of such software, developed by Microsoft® company. MSP is designed to assist project managers in developing plans, assigning resources to tasks, tracking progress, managing budgets and analyzing workloads.

Businesses are considered by some authorities to operate under the 80-20 law: 80% of business time is spent handling unexpected events and emergencies with only 20% spent on actual planning. The implementation of the present invention aims to improve such figures.

### BRIEF DESCRIPTION OF THE DRAWINGS

FIG. 1 is a schematic description of present invention system database;

FIG. 2A is a schematic configuration of 4 nodes operating in online.

FIG. 2B is schematic configuration of 3 nodes operating in online and 1 node operating in offline.

FIGS. 3-5 are charts representing steps in an examplary process of a synchronization mechanism between node and DBS;

FIG. 6 is an example of a notifications mechanism between nodes and is DBS depicted by a flow chart;

FIGS. 7-9 are an example of a transaction mechanism between node and DBS depicted by flow charts;

FIG. 10 is a schematic description of nodes hierarchy in the framework of a network of the invention;

FIG. 11 is a schematic description of nodes hierarchy in the framework of a network of the invention assigned to users;

FIG. 12 is an exemplary bar Gantt chart in accordance with a preferred embodiment of the present invention;

FIG. 13 is an exemplary TMM Gantt chart in accordance with a preferred embodiment of the present invention;

FIG. 14 is an exemplary overall Gantt chart in accordance with a preferred embodiment of the present invention;

FIG. 15 is an exemplary smart Gantt chart in accordance with a preferred embodiment of the present invention;

### DETAILED DESCRIPTION OF THE PRESENT INVENTION

An embodiment of the present invention is a software system that involves a limited yet expansive amount of interconnectable nodes within a unique network. A node in the context of the present invention is an apparatus such as a computer that communicates with a database server (DBS). The interaction between such nodes complies with a set of functional rules and topological considerations. An apparatus such as a computer that is not connected to the DBS and has an internet access referred to hereinafter as an external node. External nodes are connectable to the system of the invention usually through non-specific communications channels such as regular email connections. Any node can be defined by the administrator as being either is senior or junior with respect to another node. This hierarchical feature together with other features dictates specific task flow properties and connectivity characteristics between nodes, as well as data access of nodes to main data base. Each node employs a special visual interface (VI) which updates the node regarding statuses and processes in the system.

1. The Database Subsystem

### 1.1 Access of a Node to the Database

In a preferred embodiment of the present invention, the database is a tabular database. A tabular database is a set of data elements (values) organized using a model of horizontal rows and vertical columns. Rows in the table referred to as “records” and columns referred to as “fields”.

Changes in the DBS are permitted based on the node permissions. Each record has different fields defined in the DBS. With the values that are contained in these defined fields the DBS can evaluate which node has the permission to receive the changes. For example a table named “tasks” with fields [ID, owner, performer, state, subject] is defined by the DBS. The field “state” indicates the state of a task. For example, indicating a new task and a task that is completed. The fields owner and performer contain names of the nodes the owner of the task and the performer of the task respectively. The node in the performer field has a right to change only the “state”. A node listed in the owner field can change values in all the other fields except the ID field (once ID is assigned it cannot be changed).

In accordance with the present invention, the DBS stores the data associated with all nodes in the system. The DBS also stores the permissibility aspects of the different nodes in the network. “Static permission”, “company permission”, “dependant rights permission”, “multi-dependant permission” and “limitation permission” are references to examples of five types of node permissibility management mechanisms to insert update and or delete parts of data from and in the DBS. The term “company group” means all the users (or nodes) belonging to the same company. The term Hierarchical connective structure unit (HCSU) means a collection of nodes that include a senior and its juniors. The term “junior” means the node that is subordinate and under supervision in respect of its “senior” node. The term “senior” is a node that is a supervisor and a superior on other node in the organization. The organization can be composed from more than one company.
1.1.1 Node permission—A node has permission to access records and values in the fields of records depending on his predefined rights.
1.1.2 Company group permission—A node assigned to a user has permission to access records of the DBS, depending on:
a. values such as user or company group id in defined field of each record
b. a nodes's position in the company group and its hierarchical connective structure unit (HCSU).
c. a company group to which the nodes belong.
1.1.3 Dependent permission—Data in one table is related to the data in other tables. In general, tables can be related in one of three different ways: one-to-one, one-to-many or many-to-many. A one-to-many relationship often referred to as a “master-detail”. For example, in a one-to-many relationship, a record in table A can have none, one or more than one matching record in table B, but for every record in table B there is exactly one matching record in table A. Therefore, record B is defined as “master” record and record A is defined as “detail” record. In this type of records relationship the permeability are defined in a “master” record and all “detail” records have a permissibility based on that. In accordance with the present invention, the permissions are stored in some fields on each record in “detail” tables. The permissions are stored only in the DBS and they are used for sending “detail” records to nodes that have permission to receive these records.
1.1.4 Multiple dependent permission—this is similar to dependent permission but it is intended for tables which may have “master” records in different tables.
1.1.5 Limitation permission—This permission is limiting data interchange between DBS and node. The purpose of limitation permission is to limit data received by node with permission to access data to many nodes. An example for such node can be an administrator or someone in a high position in the company hierarchy such as a CEO. The CEO is not required to see for example data of one of his hundreds employees that are in the lowest position in the company hierarchy. Another feature of the limitation permission is that a node can change the limitations of other nodes he wishes to see. This give the system a flexibility, for example when a CEO wants to see a specific person in that is placed in the lowest company hierarchy, the CEO can change his limitation permission easily.

### 1.2 The Database Structure

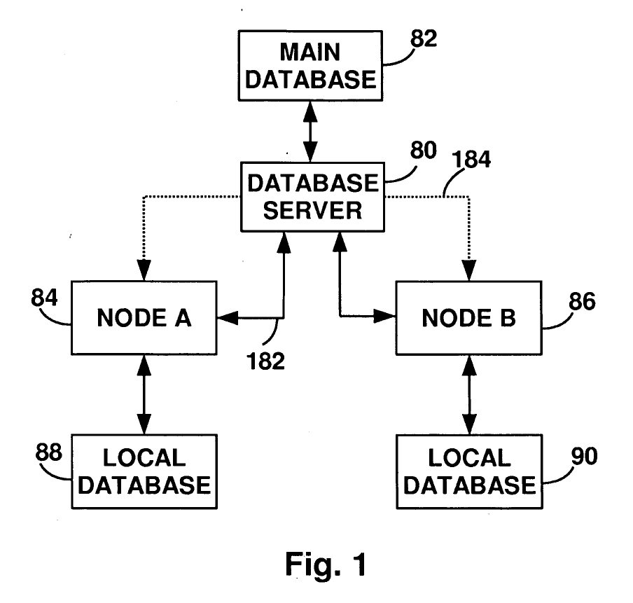

An exemplary configuration of database structure is described schematically in FIG. 1 to which reference is now made. DBS 80 retains a copy of data in the main data base 82. Node A, 84 and node B 86 are connected both to DBS 80 and corresponding local database (LDB) 88, 90. Portions of the data stored in the DBS is copied to be subsequently stored in the local database each node. Each node stores parts from the DBS in compliance with their permissions.

### 1.2.1 Identity Designation (ID):

A basic feature of the tabular database of the system of the invention is that to each record has a unique ID (UID). The ID is a complex entity composed of three parts. Part one, identifies a node and the computer he/she is logged into. Part two identifies each record that is added to a table. Part three is optional and it identifies a specific DBS if more than one DBS is used. Examples of ID formats:

a) XX-YY where XX is unique identification of node/computer and YY is an incremental value. XX and YY can be strings or numbers. XX-YY ID may look: D2AX-S31 or 12-12FA. Typically the strings are case insensitive. Allocated size of local ID can be for example twenty characters. Seven for computer ID, one for ‘-’ and twelve for incremental value.

b) DBID-XX-YY where data base ID (DBID) identifies a specific DBS the identification can be characters such as letters and numbers, the DBID is generated for each database and is unique in whole system. For example nineteen characters are allocated for DBID and one ‘-’ character.

### 1.2.2 Data Synchronization Between Nodes Respective LDB and DBS

A node can operate either in an offline or an online mode. Changes to data that a node makes in his/her LDB can be viewed using the visual interface (VI) as soon as they are made and then are put into a queue to be sent to the DBS. A queue is a stack of data on hold. A node working in the online mode sends the changes of data to the DBS update queue. For a node working in the offline mode, the changes are first kept in a queue. When the node subsequently works in the online mode again, the changes of data kept in the queue are sent to the DBS.

For a node to operate in the online mode, it should be able to communicate with DBS. In this mode changes in the data the node creates in his LDB are synchronized with DBS. If the DBS accepts and stores the is changes, other nodes that have permission to see the changes are automatically notified with the changed data, i.e. the corresponding tables of the LDBs and the DBS will have the same data. If changes are not confirmed by the DBS the changed data are updated in DBS and the updated changed data are sent back to node of the node and re-evaluated to consider resending. If after evaluation the changes can not be sent again to DBS, the LDB of the user node receives the DBS update data and the updated data can be viewed in node VI. The data of the node can be rejected for example from two reasons:

1) Actual data on the DBS and on the node LDB are different. In this scenario the DBS sends to the node of the node corrected values.

2) Data that is sent from a node to the DBS is incorrect i.e. the data are inconsistent or node do not have a permission to change specific data. In this scenario the LDB of the node receives only a rejection for his sent data. Nodes operate in offline mode when the nodes of the users are not communicating with the DBS. In this mode a node can make changes in his LDB but the changes are not synchronized with DBS and with other LDBs of offline or online nodes. When the node is on-line the changes he did in offline mode are sent to the DBS. The changes of data from other nodes that are stored on DBS, in compliance with the governing rules including node permissions are sent to his LDB.

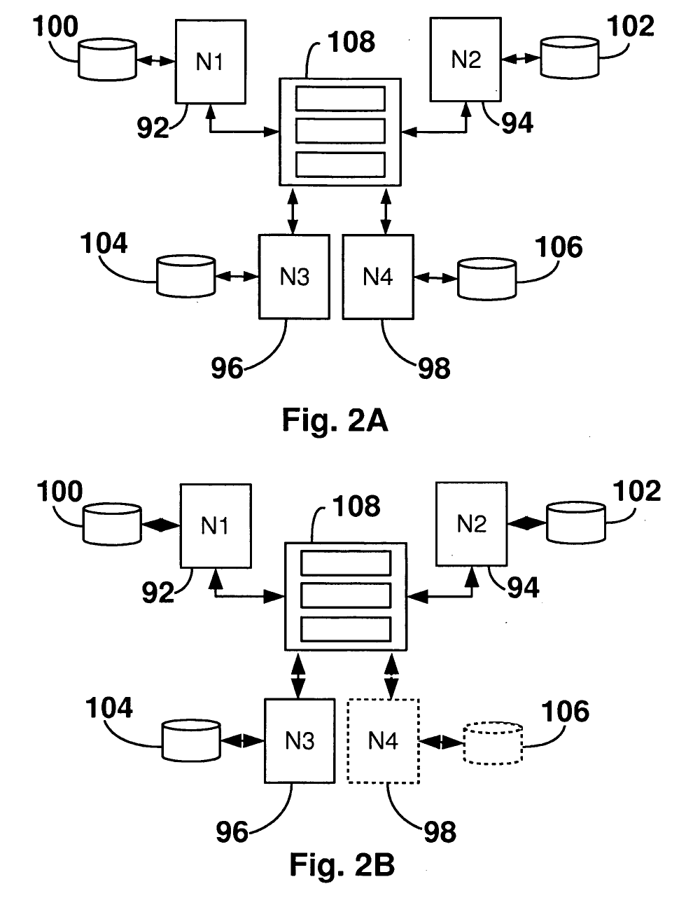

An example of configuration involving the DBS, some on-line and some offline nodes is described schematically in FIG. 2A-2B to which reference is now made. In FIG. 2A a configuration of 4 online nodes connected to DBS is depicted. Each one of the 4 nodes 92, 94, 96 and 98, has a respective LDB, 100, 102, 104, 106. The nodes are connected to DBS 108 and information is exchanged between the nodes and DBS in compliance with the governing rules including node permissions. Node 1, node 2, node 3 and node 4, not shown in FIG. 2A-2B, are assigned to nodes 92, 94, 96, 98, respectively. A communication sending/receiving respectively to/from other nodes is an example of a node operation. This operation generates changes in the data in the node LDB, in LDBs of other nodes that have permission to receive these changes and in the DBS. Considering the case where node 1, 2, 3 and 4 are working in on-line mode. Node 1 sends a task to node 4. After the task is received, node 4 switches to offline mode. In FIG. 2B, node and LDB of node 4 working in offline mode are designated using a dashed lines. While node 4 is working offline he can continue working on the task and all actions that are executed to complete the task are stored in his LDB. When node 4, turns on-line as described schematically in FIG. 2A, the LDB of node 4 is synchronized with the DBS. LDB 106 of node 4 sends changes of data to DBS 108 and LDB of node 4 106 receives changes of data from DBS 108. Most of the actions the node made before turning on-line are synchronized with DBS and LDBs, but some may not. The actions that are not synchronized are such changes made by other online nodes made at the same table when the node was offline. An example of such occurrence is explained bellow. Considering the case in which node 1 creates task intended for node 2. Both nodes operate online. Node 2 receives the task and then turns off-line. Meanwhile, node 1 redirects the task to node 3. Node 2 does not know that the task was passed to another node because node 2 was offline. When node 2 completed the task, he/she also sends a notification to node 1 about the completion of the task and from the point of view of node 2; he/she completed the tasks. The changes are first kept in a queue in node 2 LDB. When the node subsequently works online again, the changes of data that are kept in the queue can be sent to the DBS.

If the changed data of node 2 is rejected by DBS because the task was redirected to node 3, the changes that node 2 made are not accepted however, the node can send the returned data to nodes as a data that is not a task. Each operation such as tasks, assigned XML file describing the operation and therefore it's possible to restore node data.

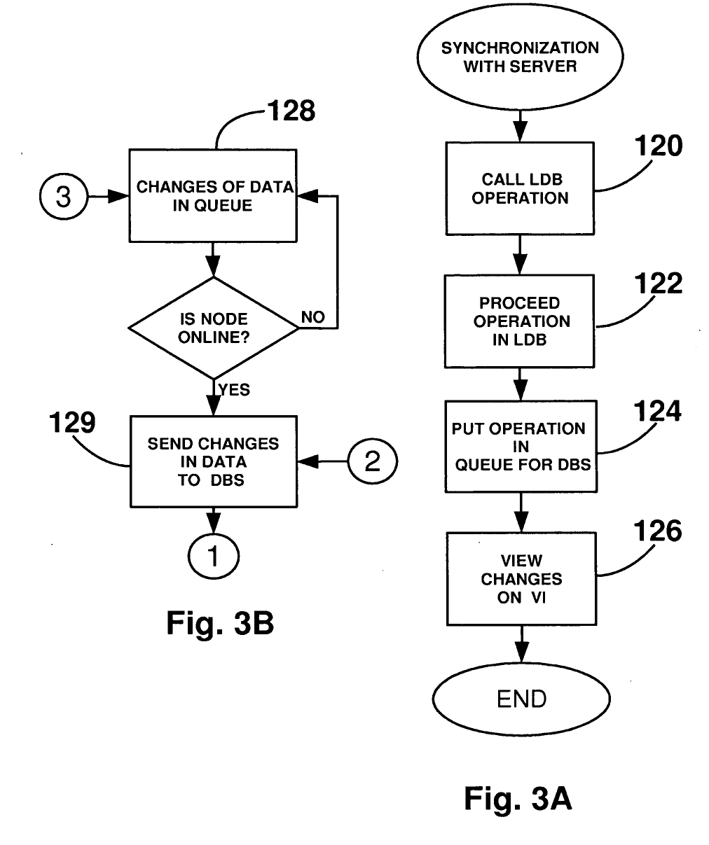

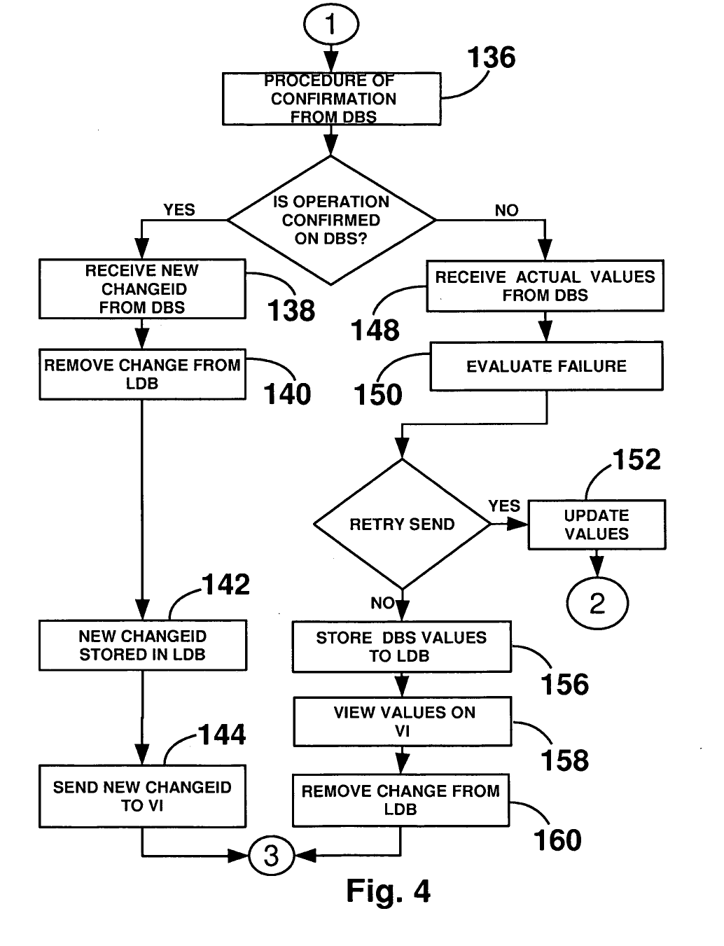

In the case that a node is working off-line, the DBS data may change by other online nodes. The offline node cannot detect the changes made in the DBS by other nodes; the changes are detected after the node turns on-line. The changes are detected by a value named for example, “change identification (ID)”. ChangeID is a unique long integer value for each record. After any change operation with a table (for example insert, update or delete) this value is increased and stored in a specific record into column named changeID. When a node is connected to the DBS, the changeID from the node's last connection to the server is stored in the corresponding tables. The node sends to the DBS a request to synchronize. Now the DBS is to send all the records that are required in order to synchronize with the node/node. These records are associated with changeID values which are higher then the respective outstanding changeID stored in the LDB of the node. A database table is allocated for storing IDs of deleted records alongside their changeId. Thus to synchronize the DBS with the LDB all the changed and deleted records are to be sent to the DBS. An example of the synchronization procedure between node and DBS is depicted by a flow chart in FIG. 3A-3B to which reference is now made. Considering the case in which a node is assigned to a user and the node sends/receives a task for/from other node, respectively. In FIG. 3A the node calls an LDB operation, to delete, insert or update data 120. The operation proceeds in LDB 122. Operation is put in queue for DBS at step 124. A node receives local notification about the change and the changes are viewed in the visual interface (VI) of the node at step 126. Referring now to FIG. 3B, some changes are made in the LDB at step 128. If the node is on-line, the changes are sent to DBS in step 129. If the node is offline, the changes of data are sent to a DBS queue. The DBS will receive the update when the node turns online. After the changes are sent to the DBS, the node waits for a confirmation from the DBS that the changes can be stored there. Referring to FIG. 4, the procedure of the confirmation by the DBS 136 will be described later on in more detail. If the changes are confirmed by the DBS, the node receives new changeID from the DBS through a notification channel at step 138 (notification channel will be described as following in more detail). The changes of data that were in a queue for sending to DBS are deleted from the LDB at step 140 and the node is ready to send another change to the DBS. The new changeID is stored in the LDB at step 142 and is sent to VI at step 144. If the changes are not confirmed by the DBS, the node receives the actual values at step 148. The node evaluates the operation failure at step 150. If the node re-sends the changes to the DBS, the LDB values are updated with actual values received by the DBS at step 152 and the node sends the updated changes to the DBS. The process goes on to step 129, in FIG. 3B. If the user does not want to retry sending the changes to the DBS, the node stores the corrected DBS values in the LDB at step 156. The corrected values are viewed in VI at step 158 and the node removes the changes from the LDB at step 160. At this stage the node is ready to send another change to the DBS at step 128, as described in FIG. 3B, to which reference is again made.

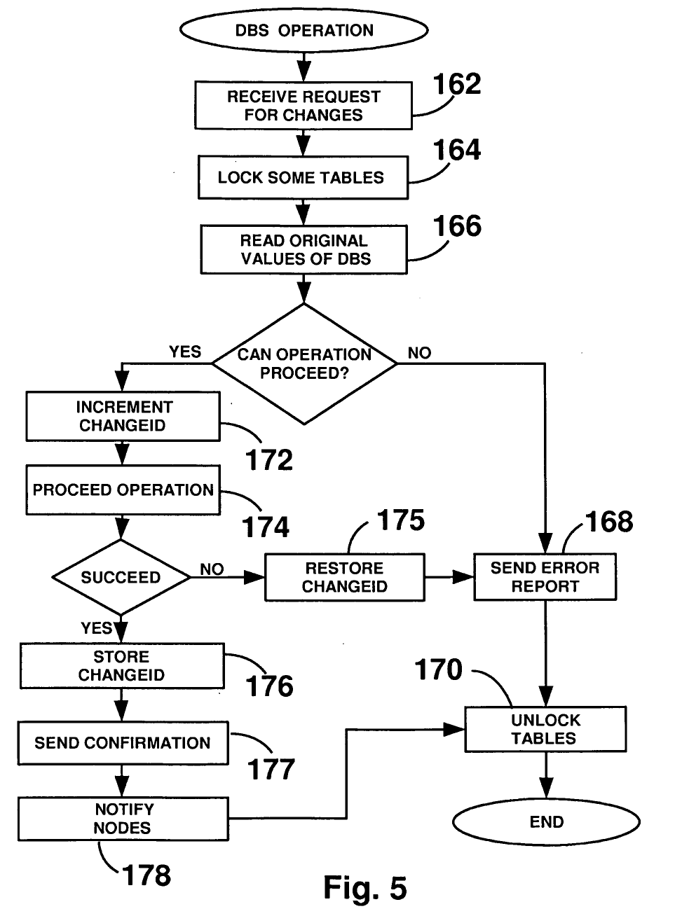

An example of a process for receiving confirmation from the DBS is described in FIG. 5 to which reference is now made. The DBS receives a request for making changes such as a new value, a new changeID, ID or table name from a node at step 162. The DBS locks some of the tables at step 164. The DBS then retrieves the original record values on the DBS that relate to the received changes from the node at step 166. The DBS checks if the node operation can be stored. For example, to accomplish delete or update operations in some records, the DBS checks if such records exist and the changeID of the node and the corresponding changeID of the DBS are the same. In the case of insert operation, the DBS checks that a record with the same ID does not exist. The DBS also checks if the node has permissions to proceed further the operation based on his permission level. If the operation cannot proceed, the DBS sends back to the node an error report at step 168 to the node, and unlocks the DBS tables for changes to be made at step 170. If the operation can proceed, the changeID is increased at step 172 and the operation then proceeds with the updated changeID at step 174. If the operation can not proceed, DBS restores changeID values at step 175, the DBS sends back to the node an error report as well, at step 168. The DBS then unlocks the tables to enable changes to be made, at step 170. If the operation has, succeeded the new values of the changedID are stored at step 176 and the DBS sends a confirmation to the node at step 177 notifying that the new values are stored successfully in the DBS. Those nodes that have permissions to see the new changes are also notified by the DBS at step 178. After the notification, the DBS tables are unlocked to permit changes, at step 170.

### 1.2.3 Notifications

A node has two channels of information to the DBS. One channel is used to run the operations on the DBS and the other is used to receive notifications about the changes of DBS records that were brought about by other nodes.

Reference is again made to FIG. 1 showing structural aspects of the components of the system of the invention which participate in the notification as discussed above. Node A 84, assigned to a user, sends changes of data to DBS. Node B 86 is assigned to another node. Considering the case that Node B has a permission to receive data changes of Node A, node A sends data to the DBS via channel 182, referred to as “master channel”. DBS 80 permits node B 86 to receive such data and sends it to node B via a second channel referred to as “notification channel” 184. This means that node B does not need to initiate a request for receive data to the DBS in order to receive data changes of node A and the changes are received without delay.

For example, suppose there are three nodes: John is senior to Bob and Bob is senior to Tom. John creates a record in table “tasks” and sets himself as an owner and bob as a performer. The DBS receives this record over the “master channel”. The DBS identifies the hierarchical relationships between nodes and therefore sends notification to Bob with all the data John inserted. Tom on the other hand receives nothing. When Bob sends a task to Tom and subsequently Tom completes the task, a notification that Tom completed the task is sent to the DBS and the notification is sent by the DBS both to Bob and to John because John is senior to Bob and Bob is senior to Tom.

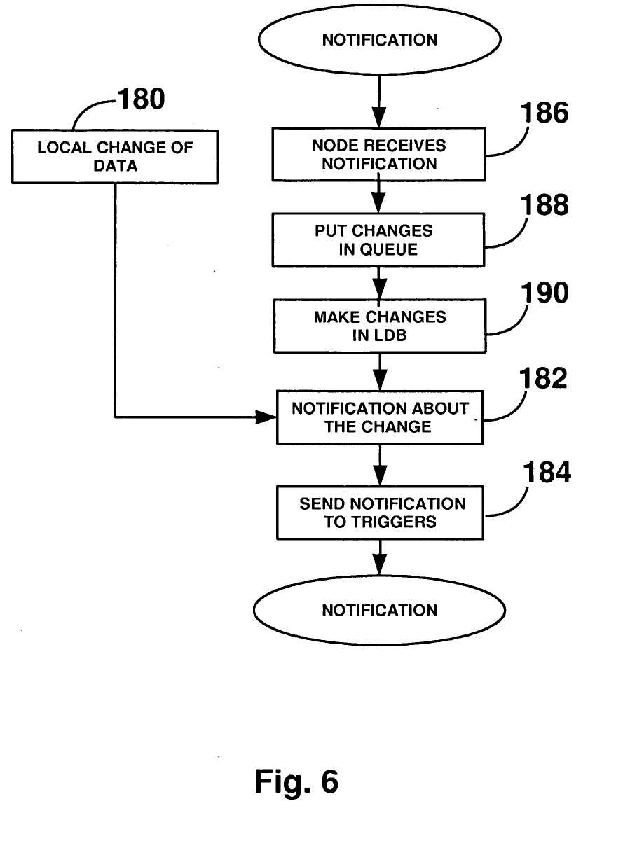

The nodes are synchronized such that the changes of data are sent through the “notification channel” directly to the connected nodes that need to receive these data. The data is stored in the respective nodes' LDBs and all the VI applications of the nodes related to the received changed data are notified. With reference to the above example with John, Bob and Tom, John opens a window application where he types information, for example a production task to Bob. Suppose he has on another application window an open list of all the tasks between him and Bob. When he sends the data, a local notification about the change is created, and viewed in the VI of John's node. The change is stored in the John's LDB and is sent to the DBS. The DBS sends a notification to Bob. Bob on the other hand may have opened a similar list and the same notification which updated John's database also updates Bob's LDB. An example of the notification mechanism between the nodes and the DBS is depicted by a flow chart in FIG. 6. If there is a local change of data at step 180 in a LDB all open dataset in the LDB are notified about the change and its VI is updated about the local change at step 182. Notifications are also sent to the attached database triggers at step 184. A database trigger is a procedural code that is automatically executed in response to certain change in a particular table in a database with some conditions. If a node receives notification from DBS at step 186, the change is put in queue in the LDB at step 188. The LDB then proceeds to make changes at step 190. After the change is stored in the LDB all open datasets in the node are notified about change and its visual is updated. A notification is also sent to the attached triggers (the triggers of a particular table).

All the VI applications in all the nodes of the network are updated respectively. In most prior art database based applications a notification of change includes only a unique ID of a record which has changed or also the field which has changed. In accordance with the present invention the notification of change includes type of operation (such as insert, delete, update), unique IDs of the records, new values of the changed record and old values of changed record. In this case the node does not need to send a request to the database management system (DBMS) to open a record because all the information is available in the notification. A DBMS is a complex set of software programs that controls the organization, storage and retrieval of data in a database.

### 1.2.4 Transaction

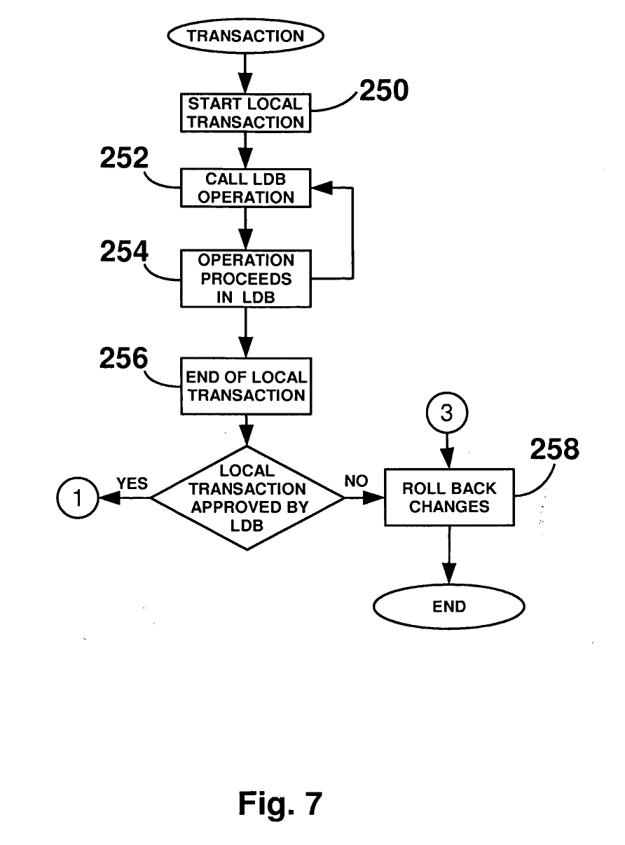

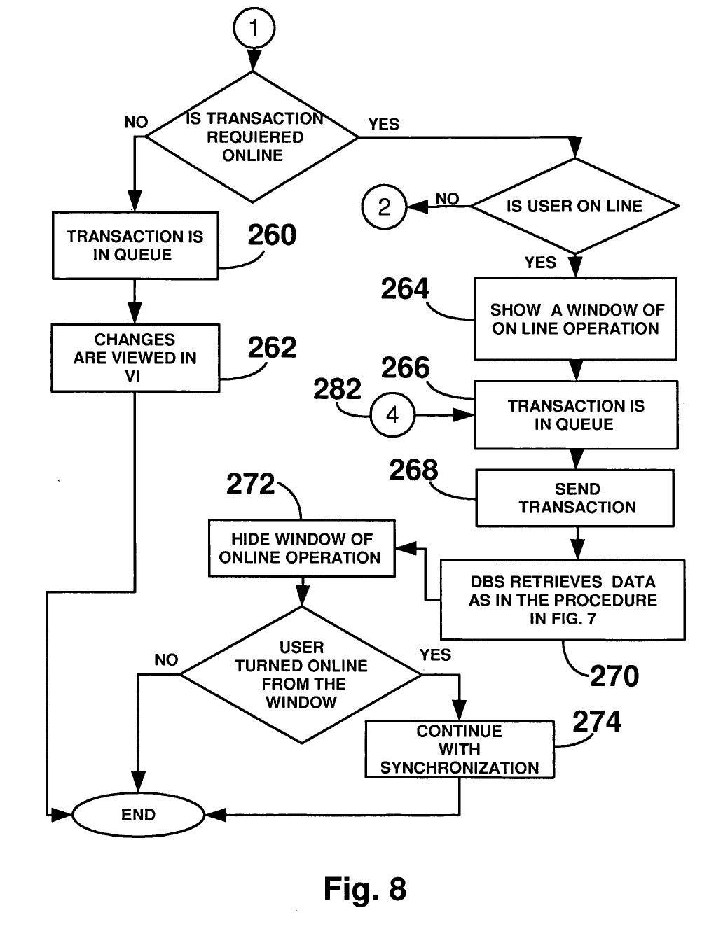

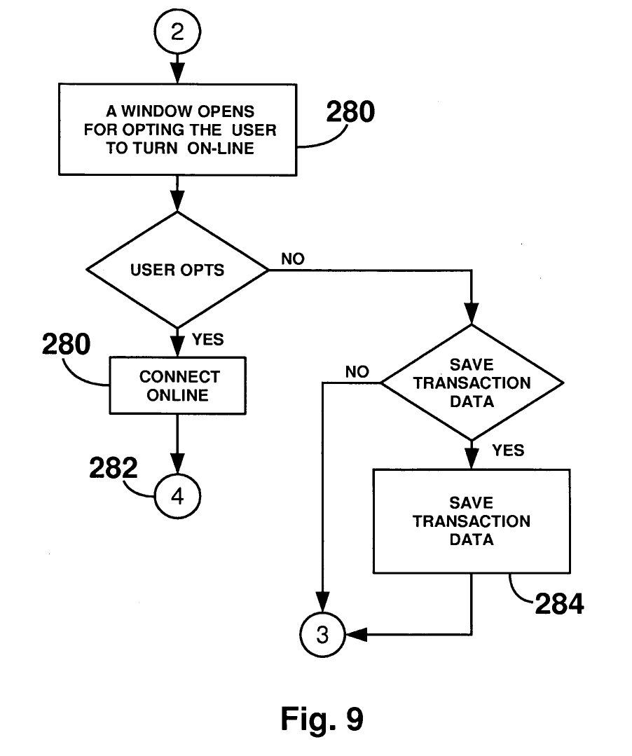

A set of changes that a node creates to be sent to the DBS is referred to hereinafter as a transaction. This set of changes can cause modifications in many tables in the LDBs and in the DBS. In FIGS. 7-9 an example of the transaction mechanism between a node and the DBS is described by flow charts. A node starts to create a transaction at step 250 and a call for a LDB operation is issued at step 252. The operation then proceeds in LDB at step 254. If the local transaction is not ended i.e there are more changes to data to be sent to the LDB, the node calls the LDB to send more changes. After the node has finished sending the set of changes at step 256, if the transaction is not approved by the LDB the set of changes are rolled back at step 258, the changes that are made in the LDB as a result of the transaction are deleted and the previous data is restored. Some transactions are made online, for example sending to the DBS a set of changes such a set of tasks. Referring to FIG. 8, if the transaction is permitted to proceed in the LDB (for example the transactions has flag, which is indicating if it requires to be done online or not) it is not required that the node is online. In such a case the transaction is sent to DBS 260 and viewed in VI at step 262 i.e. at this step the changes of the transaction of the node are notified and viewed in the node VI. If in order to send a transaction it is required that a node is on-line, if the node is on-line a window is opened in the VI indicating to the node that he is operating an online transaction and the VI is blocked for changes at step 264. The transaction is put is put on hold in step 266. The transaction is then sent to the DBS at step 268. Afterwards, in step 270, in a way similar to the one described above in FIG. 5, The DBS retrieves data. The window that was opened to indicate on-line transaction operations is hidden in step 272. If the node turned online using a window icon, the node is synchronized with the DBS at step 274 with other operations of the node and other changed data that is received from other nodes in the network. If the node does not turn on-line from the window icon, the transaction is ended. Referring to FIG. 9, if a node is not on-line, a window opens in the VI opting the node to turn online. If the node opts to turn online at step 280, the rest of the steps of the procedure from 282 are carried out. If the node does not turn online, he/she receives an option to save the transaction data. If the node does not save the data, the operation is rolled back and the transaction ends. If the node saves the transaction, it is sent later on when the node turns online, and the operation is rolled back and the transaction ends.

### The Communications Concepts

### 2.1 Communicating the Nodes

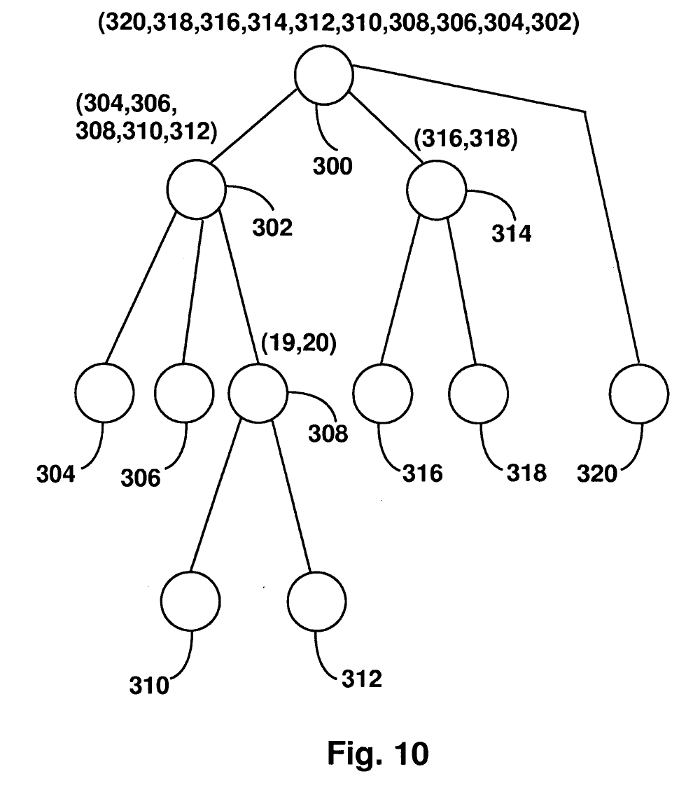

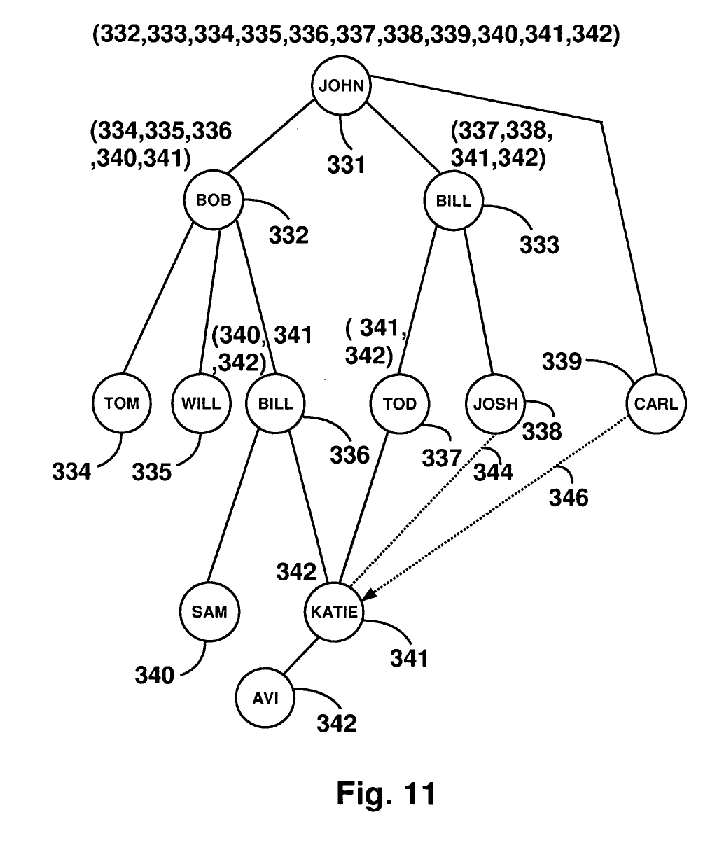

There are 4 types for routing communication between nodes. The types are referred to hereinafter as: “message”, “production task”, “command task” and “external” respectively. A node issuing a “message” type communication is able to reach any other node in the network and data associated with “message” communication of all the nodes are stored in the DBS. The DBS is a data storage and retrieval system; it stores data centrally for network nodes and also uses client-server software application to distribute the processing of that data between itself and nodes requesting/sending information. Typically the DBS uses a tabular database. A node that issues a “production task” communication can also reach any other node. In “production task” the originator of the communication sends a task to another node. A task is a definite piece of work assigned to a node. It is a unit of work within a workflow. Workflows are composed of multiple tasks which can be executed serially or parallel. A node that can be defined also as “senior” can issue a task in a routing communication type “command task” to his “juniors” and a node “junior” can not send task to his node ‘senior”. A junior can have one or more seniors from one or more company groups. The routing communication type named “external” is defined as a connection that is not associated with interaction with the main database. Nodes that don't have access to the main database are referred to as “external” nodes. The administrator or the planner of the system in a company group or organization defines the position of a node in the organization hierarchy. An example of the hierarchical relationships between nodes in the framework of a network of the invention is described in FIGS. 10-11 to which reference is now made. In the topological layout, the circles represent the nodes in the network; an index number attached to each circle represents the unique ID of each node referring to FIG. 10. Node 300, in this exemplary layout, is of highest hierarchy and therefore has access permission to all data of the DBS i.e. the data of all nodes. Node 302 has permission to access data of nodes 304, 306, 308, 310, 312 thus node 302 can access its own data as well as the data of nodes 304, 306, 308, 310, 312 that are stored in the DBS. Node 300 is a senior with respect of all nodes and node 308, for example is a junior in respect of node 302, 300 and a senior in respect of nodes 310 and 312. Node 312 for example is connected only to nodes above in the hierarchy thus he could only be a junior.

In FIG. 11 the name of a node that makes the communication is assigned in each circle. John, Bob, Bill, Tom, Will, Bill, Tod, Josh, Carl, Sam, Katie and Avi are assigned to circles 331, 332, 333, 334, 335, 336, 337, 338, 339, 340, 341 and 342 respectively. John is the head of all the nodes. Bob is the head of the HCSU including nodes, Tom, Will, Bill, Sam, Katie and Avi. Bill appears twice, Bill 336 is the head of HCSU including Sam, Katie and Avi, while Bill 333 is a head of the HCSU including Tod, Josh, Katie and Avi. Bill therefore, in this example occupies two different hierarchical orders at once.

The node that is assigned to the head of a HCSU can have bidirectional connectivity with the other nodes of the same HCSU. A node who is not a member of a HCSU can have “read only” connectivity to one or more of those members in a HCSU and only if those members are of inferior hierarchy level, in respect of the node that is not a part of the HCSU. For example, node 338 assigned to Josh has a read only data access to Katie 341. Dashed line 344 describes the unidirectional “read only” connectivity. A node who is a member or not of a HCSU can have “replacement” connectivity to one or more of those members in a HCSU and only if those members are of inferior hierarchy level. For example, node 339 assigned to Carl has a read only data access to Katie 341. Dashed line arrow 346 describes the “replacement” connectivity. Avi is also junior of Carl because Carl has“replacement connectivity” with Katie.

In another aspect, head of a HCSU can limit the amount of data of his members which he can access and view. For example a chief executive officer (CEO) can view the data of all the people in the organization. However, in order that CEO will not receive irrelevant information to make his decisions, CEO can filter out data of specific member. The filtering decision can be changed any time for any member.

3 Visual Interface (VI)

The main modules of the VI application are described below. The names of the modules are chosen to be compatible with a commercial organization management tool implemented in accordance with the present invention. The modules are referred to as follows:

is 3.1 “e-Mail 2.0”
3.2 “calendar”

### 3.3 “TM Matrix”

### 3.4 “Plans”

### 3.5 “Meetings”

3.6 “statistics”
3.7 “organization chart”
3.8 “Action list”

### 3.9 “MVI”

3.1 The e-Mail 2.0 module
The “e-Mail 2.0” module” is a VI application having its window display typically partitioned into five or more parts as follows.

Part one consists of folders in which data regarding traffic between nodes are stored. Typically, the folders are listed on the left side of the window. The folders automatically arrange the data based on its status—communications assigned to me, assigned by me, storage folders, Sent messages etc. The folders provide views of some or all of the node's open and closed cycles of communications. These views can be set to include all open cycles, or any combination of emails, assigned or self generated items, items from the node's daily or weekly task list, scheduled meetings, items due on a certain day, past due targets, and more.

One cycle of communication is defined as a communication between at least two nodes which is started by at least one node and ended by these nodes or by seniors of these nodes.

Part two is a list of items of folders and subfolders.

Part three is a preview of the items.

Part four is a chat window that shows a list of all online and offline nodes. Each online node can chat with any other online node and can send chat message to an offline node—as soon as the off line node become on line he will get the chat message.

Part five is “Favorite section”—the node can drag any folder to the Favorite section.

As already mentioned, there are four types of routing communications between nodes, “message”, “production task”, “command task” or “external”. An example of, “message” and “production task” communication types are described next.

### 3.1.1 The “Message” Communication Type

An example of a message feature is described next. A node creates a message and sends it to any other recipient. From the message sender viewpoint—the message will be placed in a folder named “TM sent items”/“pending”/“Messages sent by me”. From the recipient viewpoint the message will be placed at the recipient Inbox as well in “overall inbox”/“messages sent to me” folder. The message remains in these folders until the recipient ends the communication by clicking for example on an appropriate widget. When the communication is closed, the message is moved to another folder both in the receiver and the sending sides.

Another aspect of the “close communication” option, becomes manifest when a node receives a message or an action that do not require a response by the system. In such a case, the receiver can read the message and select the “Close Communication” option which notifies to the system and the originator that the item has been read by the node.

### 3.1.1.1 The Widgets of the “Message” Communication Type

“Require answer”—a senior node that creates a message can add the option “Require answer”. “Require answer” is a name of a function that can be displayed in the message window as a mark/unmark button. The recipient of the message cannot move the message out of his Inbox until he provides a reply.

In accordance with the present invention, the system has a control over each of the communications and it records what type of communication is sent/received. Thus, when sending a communication, only the appropriate message is sent, all the “email” or communication history is not required to be sent again. This result in a history of the communication which does not contain many duplicates of the communications as in emails applications such as Microsoft Outlook®.

“History”—this is a name of a function that can be displayed in the message toolbar. When this function is activated a complete history of the message is displayed (i.e. the message and all replies). The items are displayed chronologically. All the replies and sent data are grouped together so that the node can easily find them. In prior art email applications such as Microsoft Outlook®, usually the email application contains a string containing duplicates of communications and the node has to search through many separate entries regarding the same communication. In accordance to the present invention a node can include or exclude all the history or only parts thereof.

A “message” can be converted to any of the following routing communication types: “command”, “production task” or “plan”. For example by selecting a message or email and than clicking on a widget a window is opened and choices of conversion are displayed. After the conversion is executed the node has created a “command” or “production task” or a “plan” based on the message or the email. The original message or email and the converted message are stored also in appropriate folders.

Both sender and recipient can choose various action widgets related to message such as “closing communication”, “reply” and “forward”. Such actions are described below in more detail.
“Reply”—is an action to which if the reader wishes to respond to an e-mail message, the reply feature provides a quick way to answer the message is without keying in the e-mail address of the person who sent it.
“Reply all”—is an action to which If the reader wishes to respond to all the people, which received this email.
“Forward”—is an action to which the node that receives the message forwards the message to another node.
“Convert to other routing communication type”—is an action to which the node can convert the message to other communication type such as production task and command task or plan.
“Close communications”—moves the message to a folder named “TM sent items”/“completion” on both sides i.e. the sender and the receiver sides.

in contrast with the prior art, a sender sending e-mails for conveying messages, the communication usually develops as follows: a sender sends an email to another node; the message is moved to a folder named for example “sent”. The node who sent the mail waits for an answer. If the other node replies the sender receives a response linked with the original message. However, if the reply is belated, the sender may loose contact with original requirement and or periodically waste time checking for a reply which may never come, perhaps even forgetting about it completely. The communication may be lost.

The “production task” communication will be described next in more detail.

### 3.1.2 The “Production Task” Communication Type

In the system implemented in accordance with the present invention the communications between nodes resembles the natural human way of communicating. This is advantages in respect of the fact that the node has no burden of accommodating to a new unnatural communication method.

An example of the use and properties of a “production task” communication type is described next. An owner decides that a task needs to be performed. The term “owner” in the context of the present invention means a node that he is an owner of a task. To manage this task the owner creates a “production task” communication type that includes a target date and sometimes time for completion of the task. The task is assigned to a particular person referred to as a performer, who can be either a node using the implementation of the present invention or an external node who uses any email system for example e-mail client such as Microsoft Outlook®.

The “production” is copied to the following folders:

From the performer's viewpoint the item will be saved at the performer's “inbox” and “over all inbox”/“production items assigned to me” from [owner's Name]” folder. The system dynamically creates a folder with the owner's name where all tasks from that owner will be stored.

From the owner's viewpoint—the item will be saved at: the owner's “TM sent items/pending/production items assigned by me” “to [performer's name]” folder. The system dynamically creates a folder with the performer's name where all tasks of that performer will be stored.

The performer must complete the task on time. If the performer does not meet the target date, the message is presented at the owner's “inbox” notifying him/her that the “production” is overdue and uncompleted. Thus the owner needs not to waste time checking his/her “pending” folder for uncompleted tasks because he/she will be automatically notified of the task's overdue status.

Both owner and performer can initiate various actions related to the command or production task. Imitating the natural human way of communicating, the performer can initiate the following actions when receiving a command or a production task:

Report completion, query something about the task, ask for clarification, reject the task, ask for a date move, insert the task to an existing plan, create a new plan based on the task, redirect the task to one or more sub performers, send data interchange or tag the task with next action date that is prior to the target date of the task. In contrast to other email applications such as Microsoft Outlook® if an owner sends to performer a task in Microsoft Outlook® email the performer can delete the email and the owner will not know if the performer did the task. In accordance with one aspect of the present invention a production task cannot be deleted by the performer and he have to send a reply to the owner regarding the task.
The “Complete” action: reports the “production” as completed
When the performer completes the task, he sends a completion report to the owner. The completed report is produced for example by pressing on an action icon named “complete” that is placed in a toolbar which it is available to the performer when he selects a production task assigned to him. After pressing the “complete” icon a window for writing the completion report is opened. The completion report is sent to the owner of the task. The report then appears in:
   The performer's “pending” folder, but disappears from the performer's “inbox” and “over all production items” folders
   The owner's “inbox”, disappears from the owner's “pending” folder, but remains in the owner's “pending/production items assigned by me” folder.
      When the completion report is sent, the status of the task is changed to “completion reported”.
      Owner of a task can always perform the following group of actions named “owner's standard actions”, namely: complete a task, move its completion date, reassign the task to a different node, delegate (assign a different owner which includes denying the ownership from the original owner), send data interchange, query something about the task, tag an item or delete an item.
      An item is referred to as a task or a group of tasks.

Having received the completion report, the owner can either accept or reject the completion report. When the owner accepts completion, the task is moved to the “completions” folders on both sides:
To “My completions” folder on the owner's side
To “Other completions” on the performer's side
   If the owner adds additional text to “accept completion” action, the notification of acceptance will be sent to the performer's inbox. Once the performer reads the completion notification the performer then closes this notification, for example by clicking on a “close communication” icon.
   When the completion report is accepted, the status of the task is changed to “completed”. The system can monitor and respond specifically to a communication that has been completed at the original target date or delayed.
   When the owner rejects completion, the task returns to:
The performer's “inbox” and “production Items assigned to me” folders.
The owner's “pending” folder under Production items assigned by me
   When the completion report is rejected, the status of the task remains “Assigned”.

### The “Reject” Action:

The performer can reject the assignment of the “production task”; in this case it will disappear from the performer “inbox” and “production Items assigned to me” folders.

On the owners side, the rejected task will appear in his/her “inbox” and “production items assigned to me”, but disappear from the owner's “pending” and “pending/production items assigned by me” folders. When the performer rejects the assignment of a task, the owner of the task now becomes the performer of the task and the status of the task changes to “assignment rejected”.

### The “Clarification” Action:

Sometimes the recipient/performer may not be able to complete/accept a “production” due to a lack of data or confusing content in the message. In this case, the performer can send a clarification request to the owner. When the clarification request is sent it would then:
appears in the performer's “pending”, but disappears from “inbox” and “production Items assigned to me” folder.
appears in the owner's “inbox”, but remains in “pending/production Items assigned by me” folder.
   Once the owner looks at the task, in addition to his “owner's standard actions” capabilities the owner can provide a clarification response. When the owner provides the clarification needed, the “clarification” appears in:
the performer's “inbox” and “production items assigned to me” folders
The owners “pending” folder.
   When the performer sends a clarification request, the status of the task changes to “clarification requested” and when the owner provides the clarification, the status of the task changes to “clarification provided”.

### The “Redirect” Action:

When a performer receives a “production task” communication, he may find out that the completion of this task or part of it depends on some third party—internal in the organization or external to it. In such a case he can redirect the received “production task” to a new performer. By redirection, a new “production task” communication is created in which the performer of the original task is named for example master-performer, acts as owner of this new task and the performer of the new task is named sub-performer-1. The new task must be completed in time before the first task. When redirecting an entire task or a part of a task, the original task may be kept in the master-performer inbox or not, based on the master-performer's decision.

If the master-performer decided not to keep the original task in his inbox, the following happens:
as long as the original task has not surpassed its target date, the original task will disappears from the master-performer's “inbox” folder but remains in his/her “production items assigned to me” folder, as well as in a folder named for example “Items redirected from my inbox” folder.

If the master performer decided to keep the item in his inbox:
The item will remain in the master-performer's “inbox” folder as well as in his/her “production items assigned to me”. It also remains in the original owner's “pending” and “pending/production items assigned by me” folders.
   Thus a new “production task” is created and the master-performer now acts as the new owner. The new “production” communication appears in:
The new owner's “pending” and “pending production items assigned by me” folders.
The performer's “inbox” and “production items assigned to me” folders.
   When the task is redirected to another node, its status is changed to “redirected” and the status of the newly created “production task” is “assigned”. When the sub-performer-1 sends a completion report and when the master-performer accepts it (that is, when the redirection is completed), the status of the original “production task” is changed from “redirected” to “assigned” and the original performer receives a notification suggesting to complete the original “production task”.

### “Date Move” Action:

A recipient/performer may be unable to timely complete a “production task” by the target date. In such a case, he/she can send a request to the owner for a delay in the targeted completion date. The owner can then accept, change or reject the request.

The number of “date move” requests permitted can be uniquely established based on the definitions and or requirements of the organization. For example, “date move” requests associated with any particular task can be limited to two requests, or may be limited in time for a maximal period of ten days, or both. Any “date move” request exceeding the established limit must be directed to the performer's senior for approval.

While the request for a delay is being sent for consideration, the “production task” remains:
In the performer's “inbox” and “production items assigned to me” folders.
In the performers “pending” folder.
In the owner's “pending” and “pending/production items assigned by me” folders.
In the owner's “inbox” folder.

The request for delay is cancelled by actions such as, “complete”, “reassign”, “reject” and “delete”. When the request is accepted, the target date is delayed and the change in date is recorded. (A node can view how many times and for how many days the “production task” was delayed). The request will also disappear from the owners' “inbox” and the performer's “pending” folders, and the “sent date” will be changed to the date in which the “date move” was accepted. When the request is rejected the performer must complete the task on time and the delay request disappears from the owner's “inbox” folder and the target date is left unchanged. The request will then disappear from the performer's “pending” folder. Whether the delay request is accepted or rejected, the status of the task will remain the same as before the request was sent.

### The Query and Data Interchange Actions:

The performer can send any data (messages, attachments etc.) regarding the task to the owner or to other nodes by activating a dialogue window. A query is used when the performer or the owner would like to get some data but the lack of required data does not stop the performer from performing the task. In such a case the task stays in the performer's inbox. The performer can send a query to the owner or any other node regarding the “production” communication. The recipient must answer.

The query appears in:
The recipient's “inbox” folder.
The Performer's “pending” folder.
   The recipient answers the query. After he/she sends an answer, the query disappears from:
The recipient's “inbox” folder.
The performer's “pending” folder.
   The answer then appears in the performer's “inbox”. The performer can answer the reply to the query or closes the answer by clicking on an icon, for example named “close communication”. The answer will then disappear from the sender's “pending” folder. When the query is sent, it does not affect the status of the task.

The performer can send answer on received:
Query
Query answer
Data such as messages and attachments
   This function enables the performer/owner to track data concerning one subject.
   The answer appears in:
The recipient's “inbox” folder.
The performer's “pending” folder.
   After the answer is sent, the previous “query”, “query answer” or “data interchange” is automatically deleted from the performer's “inbox” and the sender's “pending” folders.
   When the answer is sent to the recipient, it does not affect the status of the task. The recipient closes the answer by clicking “Close communication” icon. The answer will then disappear from the performer's “pending” folder.

### The “Authorize Date Move Request” Action:

A production task, command or a plan that a performer receives from an owner has a “target date”. The “target date” is the date by which they are to be completed. In such a case as the task or plan cannot be timely executed the performer should request a “date move” request from an owner of a task. The “date move” request of the performer, designates to the owner that the task may not be completed on time which allows the owner to approve or disapprove of the “date move” request and handle the consequences of the “date move” request. The “authorize date move request” action is described next by an example. Considering the case in which senior A is a vice president of marketing. The HCSU of senior A includes six juniors namely, “junior A”, “junior B”, “junior C”,” junior D”,” junior E” and “junior F”. Juniors A, B, and C are respective area sales managers, whereas “junior D”, “junior E” and “junior F”, subordinates of junior A, are all “sales persons”. Considering the case in which “juniors A” sends a task to “junior D” with a target date of three days. A situation may occur that “junior D” asks for “date move” from junior A (his senior) without being aware of the consequences. Each node, based on his position in the organization hierarchy structure has a limited number of times that he may be allowed to move the target date of a task as well as the number of days the task move can be approve by him. For example “junior D” may get an approval for “date move request” from his senior, “area sales manger 1” up to 5 times or 10 days after the original “target date” (what ever reached first). If “junior D” exceeded his time or day limit, junior A may either perform a “reject date move request” or ask for “authorized date move” from his senior for example vise president (VP) marketing as a result of which, he will be able to add his comments to the request. VP Marketing can approve, change or reject the request. Considering the case in which the junior A exceeds his “date move” limits, a request by “junior D” will send a “date move request” to junior A may not be authorized. Area sales marketing 1 will request “date move from VP marketing. If VP marketing already exceeded his date move limits. VP marketing will then have to ask for “authorize date move” from his senior, the CEO.

### The “Tag Date” Action:

This feature is described by an example. Considering the case wherein an owner assigns an item, for example a task to a performer and the target due date is three months from the day the owner has sent the task to the performer. A situation may arise when the performer will become aware of the task only too close to the target date and in such a situation it may be too late for the performer to complete the task. To avoid such a situation the “tag date” action is used. This action adds a trigger or a flag attached to an existing or new command or production task, to be exhibited to the performer, indicating that a decision is needed.

When a production task is tagged the item appears in the performer's inbox at the “tag date” folder. The performer is asked to decide when he would like to take the next action and by that ensure the item is handled correctly. An item can be tagged by the owner indicating the performer an action may be needed prior to the target date. An item can be tagged by the performer indicating the performer an action will be needed prior to the target date. A tagged item can be presented in the “calendar” and in the “action list” modules.

### 3.1.2.1 The Actions of Owner

The assigned “production” communication is copied to the owner's “pending” and “pending/production task assigned by me” folders, and to the performer's “inbox” and “Production Items Assigned to me folders”. The status of the task is “assigned”.

The owner can carry out the following actions when he receives a notification that the communication was received.

When the owner receives a completion report, it appears in his/her “inbox”. If the owner decides to accept it, the task appears in:
The performer's “inbox” and “inbox/my production items” folders
The performer's other completions if the owner adds text to “Accept completion” the notification of acceptance is sent to the performer's “inbox”. The performer can then close this dialogue by clicking an icon such as “Close communication” icon.

When the completion report is accepted, the status of the task is changed to “completed”. When the owner receives a completion report, it appears in his/her inbox folder. If the owner decides to reject it, the task appears in:
The owner's “pending” folder and remains in his “pending/production items assigned by me” folder.
The performer's “inbox” and “inbox/my production items” folders.
   When the completion report is rejected, the status of the task remains “assigned”.

When the owner receives a clarification request in his/her “inbox”, the owner must provide the performer with a clarification. When the owner sends the clarification:
The original task remains in the owner's “pending/production items assigned by me” folder and also appears in “pending” folder. The clarification request disappears from his “inbox” folder.
The task with clarification is moved from the performer's “pending” to his “inbox” and “inbox/my product items” folders.
   When the clarification is provided, the state of task is changed from “clarification requested” to “assign”.

Sometimes the owner discovers or realizes that the task is completed before receiving a completion report. In this case the owner can mark the task as completed.
The Performer receives a notification of the completion in his/her “inbox” folder. The task is then moved from “inbox” and “Production Items Assigned to me” folder to “completions/other completions”.
The task is moved from the owner's “pending” and “pending/production items assign by me” to “completions/my completions”.
   When the owner completes the task, the status is changed to “completed”.

Under some changing circumstances, performing a “production task” can become purposeless. In such a case the owner can delete the task. The task disappears from:
The owner's “pending” and “pending/production items assigned by me”.
The performer's “inbox” and “production items assigned to me” folders.
   When the task is reassigned to another node, the status of the task remains “assigned”.

The owner can delegate the ownership of the task to a new owner. The production Item:
disappears from “pending” and “pending/production items assigned by me” folders of the original owner
appears in “pending” and “pending/production items assign by me” folders of the new owner.
   The new owner will also receive a notification in his “inbox”.
   If the original owner's “inbox” contains a clarification request, date move request or completion report, these are also moved to the “inbox” folder of the new owner together with the “production task”.
   When the task is delegated to another node, the status of the task remains “assigned”.

The owner can change the target date for completion of a task. The administrator can set up for each node the number of delay times and number of days the task can be moved. If the owner is on or over the target date limit, he must receive authorization from his senior. The request for authorization will then appear in the senior's “inbox” and he/she can either accept or reject change date. If the change is accepted, the new date is recorded. If the change is rejected the performer must complete the task on time. When the target date is changed, it does not affect the status of the task.

When the owner accepts the delay, the request disappears from:
The owner' inbox folder.
The performer's pending folder.

If a node has senior rights over some owner or performer of the “production task” and that senior node discovers that the junior does not execute his duties well (or for some other reason), he can click on an icon named for example “bypass” which executes a function that sets him as owner or performer instead of the junior. If the node has senior rights to both the owner and the performer of the task, that senior node can act only as owner. The administrator acts as owner anytime, he never acts as performer. Bypass is also displayed in the history of the “production task”.

If a node has senior rights over a junior who is the owner of a “production task” communication, the senior can use the function “bypass as owner” in order to take ownership.

The senior can also:
Send a delay request
Reassign the “production task” to another performer
Delegate the “production task” to another owner
Accept or reject performer's delay request
Accept or reject performer's completion of the “production” communication.
Clarify performer's response.
   The senior node can access the task from:
The “TM Matrix” (will be described later in section 3.3)
The data interchange or query which can be sent by the Performer (or owner) to the senior node's “inbox” folder.
His/her “inbox” folder if he/she received a carbon copy or blind carbon copy.

If a node, not necessarily an owner of a “production” communication, has senior rights over a performer, he can click on the function “bypass as performer” to become a performer.

The senior can then:
Reject the assignment of the “production”
Send a clarification request
Redirect the “production” to another performer
Send a delay request
Complete the “production”
   The senior performer can access the task
From the TM Matrix
From the his/her Inbox if he/she received a carbon copy or a blind carbon copy
   To act as performer the senior cannot at the same time be the administrator. If the senior node is the administrator, he/she can only act as an owner.

### 3.2 The Calendar Module

In this module the node can add new appointments and tasks into his calendar. He can move, modify and remove his invitations to meetings and tasks. If the node is a senior he can also access the calendars of all his juniors. The calendars of his juniors can also be displayed in his calendar application. He can, move, modify due date and remove an invitations to meetings and tasks to each of his juniors.

### 3.3 The TM Matrix Module

In another aspect of the present invention, a matrix module is implemented to enable viewing of all the occurrences within a company or companies from any view points, depending on node rights. For example, The TM matrix allows the node to see instantly the workload of tasks being handled by each company division, department or employee, and to identify overdue and incomplete cycles of tasks. The node can see all the scheduled meetings, all the unhandled emails in all the nodes inboxes as well as all the unhandled messages. The data can be presented in many forms—custom as well as predefined, allowing instant and accurate view of the overall activity in the company.

TM Matrix (TMM) represents an innovative concept in management, enabling node-defined views of the status of any or all items being worked on by any, some or all network nodes on one screen. Presented as a chart of all currently planned, in-progress, completed and incomplete action Items, the TMM provides the ability to quickly access company production and reducing time spent on tracking the progress of production.

The TMM is equipped with an advance system of filters allowing the node to quickly choose from a variety of viewpoints. Whether applied for one individual, specific nodes or for the entire company nodes, the filters create views consistent with the node choices of in-progress and planned production Items, items completed on time or beyond their assigned target date, the production Items within any specified date range, and more. The filter system has also a “Find” feature capable of locating specific words within the TMM. The TMM is a graphic presentation of plans and assigned tasks. The displayed tasks are consistent with the node rights. The TMM can present the work load of nodes based on various and dynamic “what—if scenarios” allowing nodes and mangers to better predict what should happen in the future. The TMM is totally interactive allowing the node to plan from within the TMM by graphically assigning and moving items, plans, meetings etc. The items are displayed in boxes with different colors to provide better orientation in the TMM. For easily identifying the status of production items, the TMM is color-coded. Using a color system, the node can easily check the target date compliance for an individual, department or the entire company. For example, an item that is completed on time is blue, an item overdue is red, an item completed but past the target date is brown, etc. All system colors are node defined by either the individual node or by the system administrator.

The TMM can be also accessed when assigning a “production task” and by that ensuring a reasonable target date to be assigned to the performer as the person assigning the task can see how work-loaded the performer is at any given time.

### 3.4 The Planning Module

Implementation of an idea requires proper planning, proper planning prevents poor performance. Proper planning requires a stated goal and clearly stated results that need to be achieved to achieve that goal. The goal achievement is the result of achieving all or most of the sub results. The present invention planning component provides node-defined planning levels suitable for creation of an entire plan from broadly stated strategies to a series of targets, to individually assigned “production” all of which need to be accomplished to turn any idea into reality. These planning levels range from general concepts to specific tasks needed to achieve the final desired product. This then allows execution of the plan to begin with the specific tasks, working upwards to and including complete achievement of the broadly stated ideas. In an example given herein below, planning levels are referred to as strategic plan, tactical plan, operational plan and mini plan.

### Example 1

### Three Level Planning

Planning Level 1: a strategy consisting of broadly stated targets, such as:

Target 1: “price the company product to be competitive with top 30 competitors!”.

TARGET 2: “sell company product in vertical markets!”.

Target 3: “provide better service then the customers expect!”.

Target 4: “enhance constantly company products and service!”.

Planning level 2: a tactical planning level, consisting of the steps needed to achieve the broad targets in planning Level 1, stated in a more specific manner, such as:

Mini plan step 1: “survey the prices of top 30 competitors”.

Tactical step 1: “search the market as to the opinion regarding those prices”.

Tactical step 2: “establish company prices based on steps 1 and 2 above”.

A Planning Level 2 tactical step can be written for each target identified in panning level 1.
Planning level 3 consists of operational planning and includes each action needed to accomplish the tactical steps of planning level 2, for example for target 1 and tactical step 1 the operation actions are:

Operational plan 1: “create a database for the competitor pricing data collected!”

Operational plan 2: “hire a team of 10 hourly employees to research competitors' retail pricing at the top supermarkets in the area!”

Operational plan 3: “hire a company that specializes in marketing intelligence to investigate competitors' wholesale pricing!”

The planning component allows the planning of different node defined levels as needed, with each production item for each level specifying the node responsible for completion of the item, the start date, target date for completion and other relevant data. Unlike MS Project® or other project management software tools, the implementation of the present invention allows the issuance of relevant operational actions from the plan that will then be automatically tracked for compliance at each level.

A plan module consists of one or more operational actions such as “commands”, “production task” or “external” communication which are stored in folders. The “owner” in the context of a plan module, is a node who can add tasks to a plan. The “owner” can also change the target date of the plan. A node who is the owner of individual or group of tasks in a plan is referred to herein after as “in-charge”. After the completion of all tasks, the “In-charge” can send a completion report to the “owner” of the Plan.

### 3.4.1 Plan Activation:

In other aspect of the present invention, when a node writes a plan that consists of sub plans the plan and its items are not assigned to its owners and performers. If a node has the rights to activate the plan and he activates the plan, substantially at that time all the items are assigned to the appropriate performers and owners. Once the plan is activated, each item in the plan is handled and functions as any production or command task in the system except that it is part of a plan or series of plans.

Another feature of the planning is the conditional activation of plan items. The execution of one or more items is sometimes subject to the completion of earlier item/s. In accordance with the present invention once a plan item is completed the system suggests to the owner to activate the next is item. Without this feature the planner does not have enough data at any given time to plan. This feature allows locking an overall target date and based on the dynamic activation select the needed resources and find out what are the risks on the critical path. Conditional activation can be done as simply as follows: if plan item A is completed, activate plan item B or plan item B and C etc. Or if plan item A and B and C have been completed, activate plan item A and/or B etc.

### 3.4.2 Gantt Charts

The “plan module” further includes Gantt charts plan. A typical Gantt chart provides a graphical illustration of a schedule that helps to plan, coordinate, and track specific tasks in order to embody one or more ideas. In accordance with a preferred embodiment of the present invention there are four types of Gantt charts. These four types are referred to hereinafter as “Gantt bar”, “TMM Gantt”, “Overall Gantt” and “Smart Gantt” respectively. The Gantt charts are described bellow.

### 3.4.2.1 The “Gantt Bar” Chart:

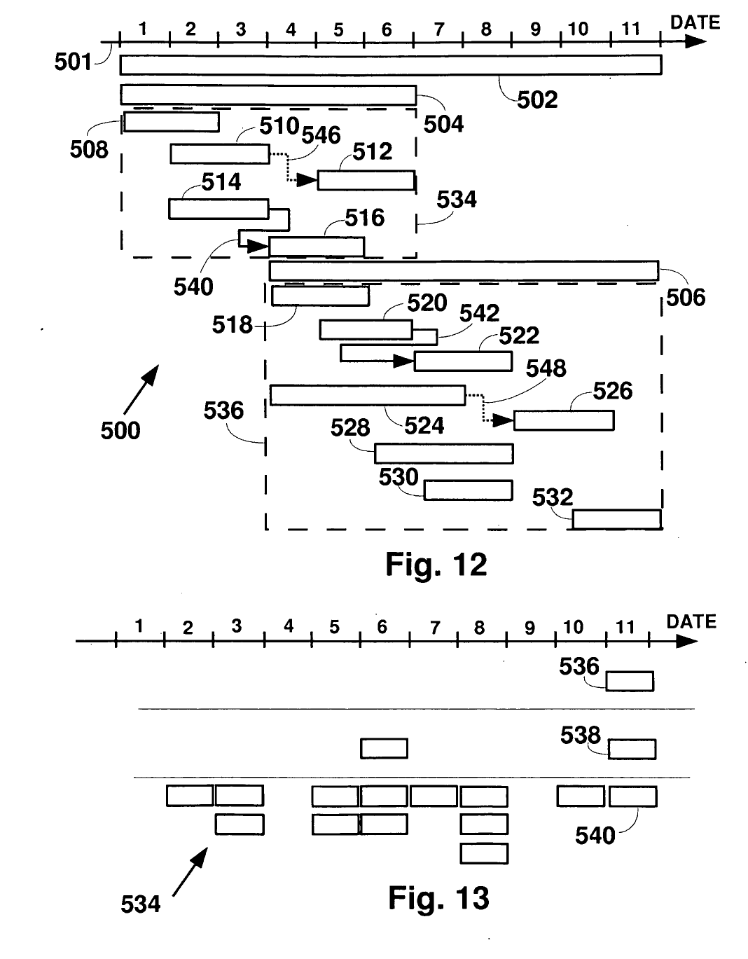

An exemplary Gantt bar chart in accordance with a preferred embodiment of the present invention is shown in FIG. 12 to which reference is now made. Gantt chart 500 is constructed having a horizontal axis 501 representing the total time span of the plan broken down into increments (for example, days, weeks, or months) in this example it is broken down into increments of eleven days. Horizontal bars of varying lengths 502,504,506,508,510,512,514,516,518,520, 522,524,526,528,530,532 designate the sequences, timing, and time span for each task. Bar 502 designates the span for implementing for example a tactical plan. Bar 504 designates a time span required for implementing an operational plan which is named hereinafter operational plan A (OPA). Bar 506 designates a time span required for implementing operational plan B (OPB). OPA and OPB are part of the tactical plan. Dashed—lined rectangle 534 designates the group of production tasks, 508,510,512,514,516 which constitute a part of OPA.
Dashed—lined rectangle 536 designates the group of production tasks, 518,520,522,524,526,528,530,532 which constitute a part of OPB. Continuous line arrow 540 designates a dependent connection between production tasks 514 and 516 Continuous line arrow 542 designates a dependent connection between production tasks 520 and 522. A continuous line arrow can designate also dependent connection between mini plans, strategic plans, operational plans, tactical plans, production tasks, command tasks and any combination thereof. In the example the continuous line arrows 542 and 540 further designate a finish-to-start (FS) dependent connection, i.e. until predecessor tasks 514 and 520 are finished the dependent tasks 516 and 522 cannot start respectively. Dashed line arrows 546 and 548 designate conditional activation of production tasks 512 and 526 respectively. A dashed line arrow can designate also conditional activation of mini plans, strategic plans, operational plans, tactical plans, production tasks, command tasks and is any combination thereof.

### 3.4.2.2 The “TMM Gantt” Chart:

An exemplary TMM Gantt chart in accordance with a preferred embodiment of the present invention is shown in FIG. 13 to which reference is now made. TMM Gantt chart 534 shows another aspect of the tactical plan example described in section 3.4.2.1. This chart shows the due date of items such as but not limited to, production task, tactical plan, operational plan, mini plan, strategic plan and command. For example, day eleven is the due date of tactical plan 536, operational plan 538 and production task 540.

### 3.4.2.3 The “Overall Gantt” Chart:

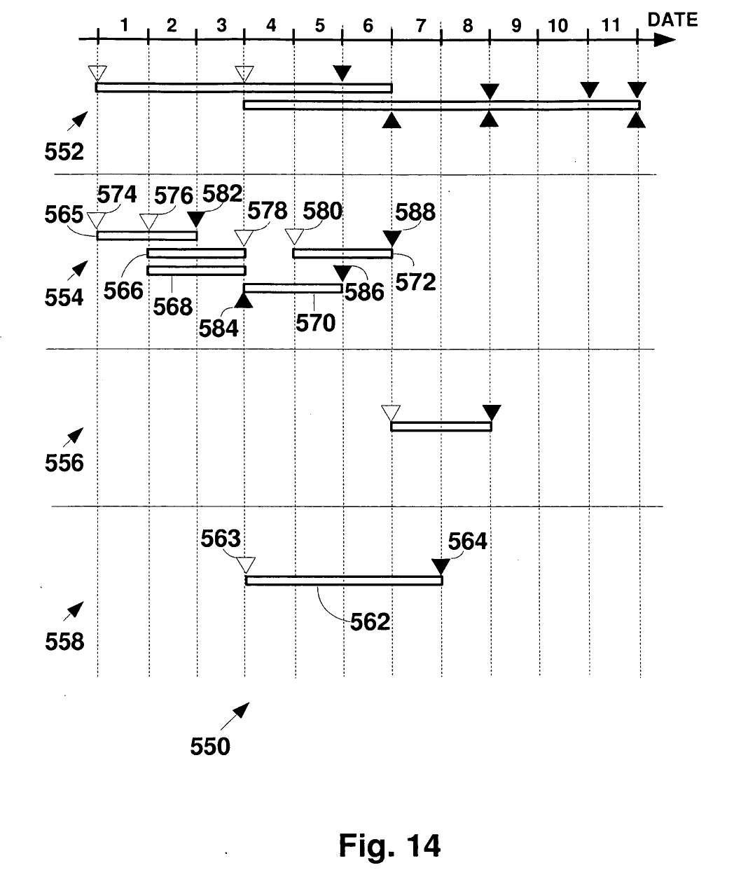

An exemplary overall Gantt chart in accordance with a preferred embodiment of the present invention is shown in FIG. 14 to which reference is now made. Overall Gantt chart 550 shows another aspect of the tactical plan described in section 3.4.2.1. Chart 550 is portioned into four sections on the vertical axis, namely 552, 554,556,558 relating to the number of performers in the plan. Each section shows the task of a performer, sections 552,554,556,558 show to the start date and due dates tasks of performers which are named A, B, C and D, respectively. For example, performer D has one task designated by bar 562. Start date of the task is designated by empty triangle 563 and due date of the task is designated by empty triangle 564. Optionally the name of the owner of the task and the name of the tactical plan is displayed, not shown. Performer B has five tasks designated by bars 565,566,568,570,572. Start dates of the tasks are designated by unfilled triangular 574, 576, 578, 580 respectively. Due dates of the tasks are designated by filled triangular 582, 584, 586, 588 respectively.

### 3.4.2.4 The “Smart Gantt” Chart:

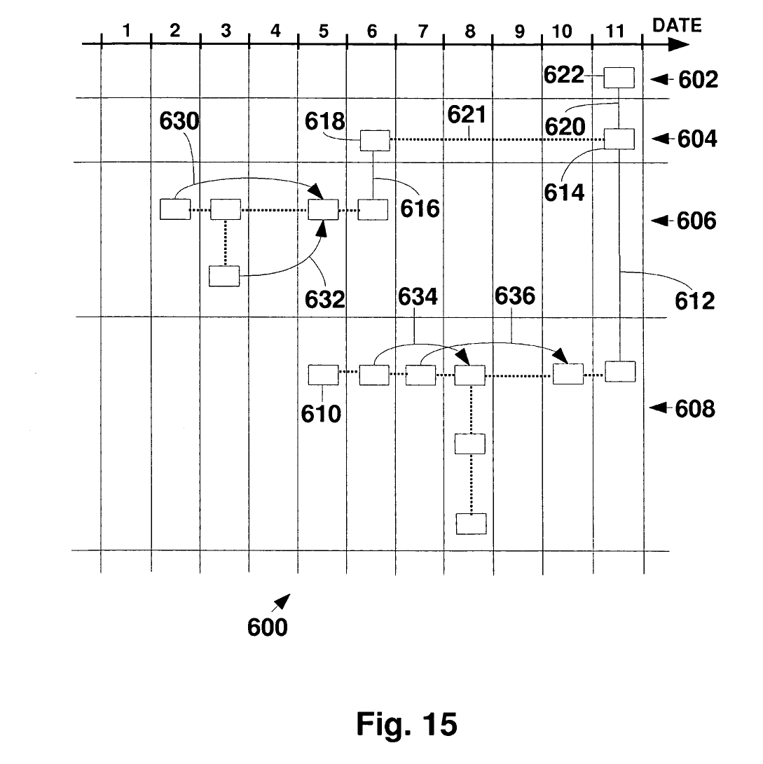

This chart shows the due date of items such as but not limited to, “production task”, “tactical plan”, “operational plan”, “mini plan”, “strategic plan” and “command task” as can be viewed in the TMM Gantt chart. In addition, the chart shows a classification to which “strategic plan”, “tactical plan”, “operational plan” or “mini plan” a task is belongs. An exemplary smart Gantt chart in accordance with a preferred embodiment of the present invention is shown in FIG. 15 to which reference is now made. Smart Gantt chart 600 demonstrates another aspect of the tactical plan example described in section 3.4.2.1. Chart 600 is portioned into four sections, 602, 604,606 and 608. In section 602 all the tactical plans of the plan is shown. In section 604 all the operational plans of the plan are shown, OPA and OPB. In section 606 all the production tasks of OPA is shown. In section 606 all the production tasks of OPB is shown. Each of these items is designated in the figure by an empty rectangle. Solid line 612, designates a link to the group of items that are part of OPB 614. Solid line 616, designates a link to the group of items that are part of OPA 618. Solid line 620, designates a link to the group of operational plans, e.g. OPA and OPB that are part of tactical plan 622. For example, referring to solid line 620 two operational plans linked by dashed line 624, are part of tactical plan 622 are linked by solid line 620. Arrows 630,632,634 and 636 designate dependent tasks, optionally the arrows are colored to account for deferent types of dependent tasks such as “finish-to-start” (FS) “dependent” and “conditional activation relations”.

### 3.4.3 Plans Statuses Definitions

A plan and some or all its items can be defined by one of the following:
“Not active”—created plans or items that have not yet been assigned to the actual performers and owners.
“Activated”—created plans or items that have been assigned to their owners and performers.
“Completed”—completed plans or items
“Deactivated”—an item or a plan that previously was activated and presently retrieved from its owners and performers.
“Cancelled”—an item or a sub-plan that is canceled after being activated.

### 3.4.4 Structure of Plans

Each of these folders contains the following plan structures:
“Strategic plan”
“Tactical plan”
“Operational plan”
“Mini plan”
“Sub Mini plan” unlimited levels.

The strategic plans are at the highest level in the structure of a plan and contain strategic items. Each strategic item may become a tactical plan. The tactical plans are at the second level of the plan and can contain tactical items and each of the tactical items may become an operational plan. The operational plans are at the third level of the plan and can contain operational items, each of which may become a “mini operation”. At the lowest level of the plan structure is the “mini plan”, which can be recreated, can contain mini operation items and mini plans. Each type of plan can also contain one or more “command”, “production tasks” or “external” communications as well as meeting items.

### 3.4.5 Actions of Owner of a Plan

After owner has sent a plan to the DBS, he can initiate for example the following actions.
Change the target date of the plan
Accept the requested date change
Reject the requested date change
Provide clarifications
Send a query regarding the plan
Send a data such as messages and attachments regarding the plan
Delete the task
   3.4.6 The “in-Charge” Actions
   The “in-charge” can initiate for example the following actions.
Send a “clarification” request;
Send a “date move” request;
Send a query regarding the plan;
Send a data (such as messages and attachments regarding the plan);
Send an answer to a query.

### 3.4.7 Rights of a Node in a Plan

The rights of a node in a plan are defined relative to a plan or a part thereof. By default, the system will grant the node rights over a plan or part of a plan based on the node function in the plan, however, the plan's owner or a senior may grant any rights over his plan to any node in the system. Nodes rights in a plan are bundled as for example: “sub owner's rights”, “performer's rights”, “read only rights”, “parent header rights” and “inherited rights”. A detailed description of the aforementioned rights is described bellow.
“Sub owner's rights”—a performer can see the plan and perform “date move” request, “clarification” request, “reject”, “completion report”, “Redirect” as well as the basic actions—“Data Interchange” and “Query”. The “sub owner's rights” allow the node to act as an owner on the plan's items such as “production task”, “mini task”, operational task”.
“Performer's rights”—a performer can perform a “date move” request, “clarification” request, “reject”, “completion” report, “redirect”, “data Interchange” and “query”. A node with performer's right cannot insert, delete, activate or deactivate steps of the plan.
“Read only rights”—give the node the rights to only see the plan and its steps with no other rights.
“Parent header rights”—give the node the right to see the plan's subject only. The node will not see the plan's body and will not see the plan's steps.
“Inherited Right”—the performer inherits the rights based on his function at the plan and its steps—the owner gets owner's rights and the performer inherits the owner's rights.
The table bellow is an example showing the rights granted for “owner”, “sub owner”, “performer” and “read only” rights.

| | | Sub | | Read |
|---|---|---|---|---|
| Ability Granted | Owner | Owner | Performer | Only |
| Change the plan | Yes | — | — | — |
| Add item to the plan | Yes | Yes | — | — |
| Delete items from the plan | Yes | Yes | — | — |
| Activate items of the plan | Yes | Yes | — | — |
| Deactivate items of the plan | Yes | Yes | — | — |
| Cancel Items | Yes | Yes | — | — |
| Convert items types of the | Yes | Yes | Yes | — |
| plan | | | | |
| Change node rights of a | Yes | Yes | — | — |
| performer | | | | |
| Change item of plan | Yes | Yes | Yes | — |

### 3.5 Meeting Management Module

In another aspect of the present invention a meeting management module ensures proper setting of meetings, assignment, tracking mechanisms for all tasks resulting from meeting discussions and the proper handling and management of meeting minutes and follow up meetings.

The meeting management module includes the following features:
inviting participants,
confirming participation,
setting and issuing meeting agendas,
confirming meeting agendas,
booking meetings venues and communication methods,
keeping and managing meetings minutes including the proper management of the meeting minutes,
managing follow up meetings.
   Its features allow the immediate issuance of tasks directly from the meeting notes and include a link system, linking current meetings to the records of all past meetings on the same subject, enabling a running record for each item of discussion and a quick and easy view of the status of all previously issued related tasks.

A node can invite other nodes to a meeting. Nodes referred to as external nodes can be invited to the meeting as well. The invitation can be for example carried out by way of a phone call, video conference, skype or any other communication channel.

At first the meeting is created and published. It means that a person who is responsible for the meeting creates the meeting and sends a meeting invitation to Inboxes of all meeting participants. The meeting can be saved in their calendars as well. After the invited parties confirm their attendance the person responsible confirms the meeting so it can be started. The participants can ask to change the venue, the agenda, the location and the form of the communication and in such case the system will mange and track the needed changes to completion utilizing the same “production” principals. After the meeting is started it is possible to write down records from the meeting and to assign orders directly. During the meetings command, production tasks and plans can be assigned in a form that will link them to the meeting or the meeting subject.
The system manages the dynamic participation so as to cater to people that join and leave the meeting. Once the meeting has been completed, optionally the minutes get distributed to the appropriate people and managed until a confirmation and agreement on the minutes has been achieved. Follow-up meetings can be set at any time. Full meeting history management is implemented allowing for the view of the meetings based on their time, subject, participants, projects, location, key words and practically almost any condition. The system allows for meeting agenda management—ensuring the meeting is happening according to the planed time. The meetings decision and minutes can be inputted by writing into electronic hand writing capturing device and attached to the meetings or its “productions”. While at the meetings two or more participants and non participants can chat using private or public chat where public chats are distributed to all meetings participants. At the meetings the participants can share their screens with one or more participants.

A system of the present invention is equipped with a color coding system enabling a quick assessment of the status of any communication, production item or target. For example, an item that is completed on time is blue, an item overdue is red, an item completed but past the target date is brown, etc. All the color codes are node defined by either the individual node or by the system administrator.

### 3.6 The Statistics Module

A node is expected to accomplish actions regarding his tasks. The node has all sorts of duties and responsibilities connected. The efficiency of a node can be evaluated by looking at the end result of all his activities and get a succinct articulation of what it is that the node produces that has value. This is referred to as node results. The concept of node results and expected results provide an answer to the identification of finite deliverable results for all personnel in an organization as well as the organization itself. They allow the measurement of the productivity of staff. A statistical analysis of a production of a staff is an approach aimed at enhancing the production in organization.

The “statistics module” graphically indicates the actual production of an individual, area or organization without the need for guessing.
Decisions are thus based on facts and are not based on conjecture or whim.
Planning can thus be accurately completed and non-productive staff identified to the benefit of the company as a whole.
The organization chart model provides a tool to define nodes' actions and their expected results. The organization chart module will be described later in more detail.
The “statistics module” provides the ability to automatically measure production across the organization and hence provide a real-time dashboard for executives and staff. Examples for production Items statistics:

“Completed”—statistics of completed production items according to finishing date.

“Completed on time”—statistics of production Items completed on time according to finishing date.
“Delayed”—statistics of delayed production items according to target date.
“Effectiveness”—percentage representation of number of actions to number of production items.
“Moved”—statistics of moved production items according to finishing date
“Planned”—statistics of planned production items according to date of creation.
   In each kind of statistic, the statistics could be grouped by date.

### 3.7 Organization Chart Module

The organization chart (OC) is an intuitive way to arrange command line and production lines as well as a way to setup node rights. The OC supplies an approach to node rights. It provides a way to show where each person is in the organization in terms of the organization hierarchy. The OC provides a way to define the expected result from each person in the organization as well as from each part of the organization.
The OC module can provide a way to draw ideas (used in brain storming), describe organizational process and establish electronic follow up methods thereafter. The OC is created only by the administrator.

### 3.8 The Action List Module

An “action list” is a list of tasks created by the node to organize and plan his work better. The “action list” can be divided into “day action list” and “week is action list”. The “week action list” can also be configured for longer or shorter periods of time. The node decides on the functional time period. The node can also add to the “action list” his/her production tasks and commands and/or uncompleted tasks from previous “action lists”. The main window consists of three sections which will be described later in more detail:
As an example the filters and calendar are displayed in the left hand section of the main window. The list of “action list” is in the upper right hand corner and the action list preview in the lower right corner.
With the filters feature for “action list”, a node can view the “action list” of other nodes (the node can view only the “action lists” of a node he has rights to). The node can view “action lists” that have not yet been sent to DBS, “action lists” that have already been sent to DBS and he can view completed “action lists”. With the calendar feature the node can select the date of the “action list” he want to view, or the date to create a new “action list”. In the list of action lists the node can view status, performer, post of the performer (for example CEO), days of the action list, start date and end date of an “action list”.
The preview of an “action list” displays, status of the “action list”, performer name, post of performer, date of the “action list” start and end date of the “action list”. The tasks of the “action list” are numbered and listed in column. For each task the node can view:
A checkbox for completion—this checkbox can be marked if the task is completed, it can be unmarked as well. Another checked box means the task was moved to another action list and completed there. An arrow in the checkbox means the task was moved to another action list and has not been completed yet.
Subject
Contact
Start time
End time
Icon—click on this icon to display the details of a “production” communication, uncompleted action list or week “action List”.
“Red cross”—click on this icon to cancel (but not complete) a task. This will not affect creation of the new “action list”. (When an “action list” is not completed by the given date, it cannot be edited. The uncompleted tasks can only be moved to the next “action list”).

### 3.9 The MVI Module

The name MVI is an acronym of multiple viewpoints inbox. MVI is a VI application in which a node can creates one or more virtual panels that can be placed anywhere on the screen and the node can decide what kind of data is presented at that panel. For example a node can decide to show two virtual panels with “TMM”, one panel with “Action List” and one with “Meetings” module. The panels can be arranged in many forms. The form in which a node arranges the panels can be saved as standard view to be selected in the future. Since each node in the system sees different data and since one may handle meetings, tasks etc the MVI concept allow the node to see one or more panels with different data and functions from different node viewpoint. For example one node can see on one screen two virtual panels with TMM—one from his own viewpoint and another from a plan viewpoint while at the same time see his or other action lists on other panels. Unlike emails or any other planning system the implementation of the present invention allows the node (subject to node rights) to see different viewpoints and hence enable correct evaluation and correct decision making.

1. An organizational management system including interconnectable nodes, wherein each node incorporates a local data base (LDB), said system comprising:
a communication network, wherein the interaction between said nodes complies with a set of functional rules and topological considerations;
a visual interface (V1) which updates a node regarding statuses and processes in the system employs each of said node;
at least one data base server (DBS) employing a database, connected to said nodes, said DBS stores at least permission data of all said nodes;
each node having two channels of information connecting to said DBS, one for running operations and the other for notifying the changes in the DBS record that were brought about by other nodes.

2. An organizational management system as in claim 1, wherein said interconnectable nodes and external nodes are define as being either senior or junior with respect to another node.

3. An organizational management system as in claim 1, wherein said LDB and said DBS are tabular databases.

4. An organizational management system as in claim 1, wherein each record of said tabular database has a unique ID (UID) which is a complex entity composed of three parts part one, identifies a user and the computer said user is logged into, part two, identifies each record that is added to a table, and part three is optional and it identifies a specific DBS if more than one DBS is used.

5. An organizational management system as in claim 1, wherein changes in said DBS are permitted based on node permissions to make such changes.

6. An organizational management system as in claim 1, wherein said DBS stores the data associated with all nodes and also stores the permissibility aspects of the different nodes in the network.

7. An organizational management system as in claim 1, wherein portions of the data stored in said DBS is copied to be subsequently stored in the local database (LDB) of each said node.

8. An organizational management system as in claim 1, wherein each node stores parts of data in the LDB from said DBS in compliance with the permissions of said nodes.

9. A method for synchronizing data between nodes, said method comprising:
incorporating a local database (LDB) and database server (DBS) employing a database wherein changes to data that a node makes in its LDB is viewed using the visual interface (V1) as soon as they are made and then are put into a queue to be sent to the DBS.

10. The method of claim 9, wherein for a node working in offline mode, changes made to data are first kept in said LDB; and when said node subsequently works online, said changes of data are sent to said DBS.

11. The method of claim 10, wherein for online nodes able to communicate with DBS, changes in the data by a node in its LDB is synchronized with DBS;
wherein after said DBS accepts and stores said changes, other nodes permitted to see said changes are automatically notified about the changed data by a notification channel, changes unconfirmed by said DBS are sent back to the sending node of the user and re-evaluated to consider resending; and
wherein a notification about such re-evaluated changes that cannot be sent to said DBS is sent to said LDB of said re-evaluating node receives DBS wherein it can be viewed in a V1 of said node.

12. A method for routing data between nodes the method comprising:
four communication types: “message”, “production task”, “command task” and “external”;
wherein, a node issuing a “message” type communication is able to reach any other data of nodes in the network and data associated with “message” communication of all the users are stored in a DBS;
wherein a node issuing a “production task” communication can also reach any other node, the originator of the communication sends a task to another user;
wherein a node defined as “senior” issuing a “command task” routing communication type to his “juniors”; and
wherein a user issuing “external” communication is defined as a connection that does not interact with the main database, and does not have access to the main database.

13. The method of claim 12, wherein a “junior” has one or more “seniors”.

14. A visual user interface (V1) application for an organization management tool comprising:
folders in which data regarding traffic between users are stored;
said folders provide views of some or all of the user's open and closed cycles of communications; and
wherein said views can be set to include all open cycles, or any combination selecting from a group of emails, assigned or self generated items, items from the user's daily or weekly task list, scheduled meetings, items due on a certain day, past due targets.

15. A visual user interface (V1) application for an organization management tool as in claim 14, further comprising a calendar module in which:
a node adds new appointments and tasks into its calendar;
said node can move, modify and remove its invitations to meetings and tasks;
for a senior node, access is permitted to calendars of all his juniors;
for juniors node, calendars of his j can also be displayed in his calendar application; and
said senior nodes can move, modify due date and remove an invitations to meetings and tasks to each of its juniors.

16. A visual user interface (V1) application for an organization management tool as in claim 15, further comprises a matrix module in which:
said module enable viewing of all the occurrences within a company or companies from any view points, depending on user rights;
the user can see all the scheduled meetings, all the unhandled emails in all the users inboxes as well as all the unhandled messages;
data is presented in forms selected from the group consisting of custom, and predefined, allowing instant view of the overall activity in the company; and
enabling user-defined views of the status of any or all items being worked on by any, network nodes on one screen.

17. A visual user interface (V1) application for an organization management tool as in claim 16 wherein, said status of any or all items being worked on by any, some or all network users on one screen presented as a chart of all currently planned, in-progress, completed and incomplete action Items.

18. A visual user interface (V1) application for an organization management tool as in claim 16 wherein, said matrix module present the work load of users based on various and dynamic scenarios allowing users and mangers to better predict what should happen in the future.

19. A visual user interface (V1) application for an organization management tool as in claim 16 wherein, said matrix module is totally interactive allowing the user to plan from within the TMM by graphically assigning and moving items, plans and meetings.

20. A visual user interface (V1) application for an organization management tool as in claim 14, further comprises a “statistics module” in which said “statistics module” provides the ability to automatically measure production across the organization and hence provide a real-time dashboard for executives and staff.

21. A visual user interface (V1) application for an organization management tool as in claim 14 further comprises a plan module, wherein:
a user-defined planning levels suitable for creation of an entire plan from broadly stated strategies to a series of targets, to individually assigned “production” all of which need to be accomplished to turn any idea into reality and
planning levels ranging from general concepts to specific tasks needed to achieve the final desired product;

22. A visual user interface (V1) application for an organization management tool as in claim 21 wherein, when a user writes a plan that consists of sub plans the plan and its items are not assigned to its owners and performers;
if a user has the rights to activate the plan and he said user activates the plan, substantially at that time all the items are assigned to the appropriate performers and owners; and
once the plan is activated, each item in the plan is handled and functions as any production or command task in the system except that it is part of a plan or series of plans.

23. A method for synchronizing data involving nodes working offline, nodes working online and database server (DBS), when a node reconnects to the DBS, the changes are detected by a unique ID (UID) which is a unique long integer value for each record, the UID from the user's last connection to the server is stored in corresponding tables, subsequently the node sends to the DBS a request to synchronize, subsequent to which the DBS is to send records associated with such UID values which are higher then the respective outstanding UID stored in the LDB of the node, and wherein a database table is allocated for storing IDs of deleted records alongside their UID to synchronize the DBS with the node LDB all the changed and deleted records are to be sent to the DBS.
